(19) United States
(12) Patent Application Publication
(10) Pub. No.: US 2021/0081855 A1
(43) Pub. Date: Mar. 18, 2021

(54) MODEL-DRIVEN ESTIMATION OF AN ENTITY SIZE

(71) Applicant: Oracle International Corporation, Redwood Shores, CA (US)

(72) Inventor: Alden Ott Timme, San Francisco, CA (US)

(73) Assignee: Oracle International Corporation, Redwood Shores, CA (US)

(21) Appl. No.: 16/813,576

(22) Filed: Mar. 9, 2020

Related U.S. Application Data
(60) Provisional application No. 62/900,610, filed on Sep. 15, 2019.

(51) Int. Cl. G06Q 10/06; H04L 29/08; G06N 20/00; G06N 5/04; G06K 9/62; G06F 16/9535

(52) U.S. Cl. CPC G06Q 10/067; G06Q 10/06398; H04L 67/306; G06F 16/9535; G06N 5/046; G06K 9/6257; G06N 20/00

(57) ABSTRACT

Techniques for estimating entity sizes are disclosed. The techniques include collecting features comprising a set of attributes of a first entity, wherein the set of attributes comprises an industry of the first entity and a presence score corresponding to a detected presence of the entity in each of a set of forums. The techniques also include applying a first machine learning model to the features to generate a first prediction of a first number of employees in the first entity. The techniques further include matching the first number of employees to a configuration parameter mapped to one or more users of a platform and updating, for the one or more users, a user interface of the platform to include output representing the first entity.

### BENEFIT CLAIMS; RELATED APPLICATIONS; INCORPORATION BY REFERENCE

This application claims priority to U.S. Provisional Application No. 62/900,610, entitled “Model-Driven Estimation of an Entity Size,” filed 15 Sep. 2019, which is hereby incorporated by reference.

The subject matter of this application is related to the subject matter in a co-pending non-provisional application, entitled “Optimization of Online Advertising Assets,” having Ser. No. 15/824,833 and filing date Nov. 28, 2017, which is hereby incorporated by reference.

The subject matter of this application is related to the subject matter in a co-pending non-provisional application, entitled “Managing Progressive Statistical IDs,” having Ser. No. 14/791,105 and filing date Jul. 2, 2015, which is hereby incorporated by reference.

The subject matter of this application is related to the subject matter in a co-pending non-provisional application, entitled “Extending Audience Reach in Messaging Campaigns Using Probabilistic ID Linking,” having Ser. No. 14,831,565 and filing date Aug. 20, 2015, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to estimating entity attributes. In particular, the present disclosure relates to model-driven estimation of a size of an entity such as, for example, a for-profit company or a non-profit organization.

### BACKGROUND

Applications and data are increasingly migrating from on-premise systems to cloud-based software-as-a-service (SaaS) systems. Such cloud-based systems are able to keep the data up-to-date in a centralized location. However, some types of data in cloud-based systems may be missing and/or require manual retrieval or verification, which limits the functionality or usability of the cloud-based systems.

For example, public companies disclose their numbers of employees, revenue, earnings, industries, corporate structure, and/or other information relevant to the companies' financials and operations in regular filings or reports. On the other hand, smaller or privately-owned companies are not required to disclose the same information in regular reports or public records, which can prevent categorization of the companies into different segments and/or targeting of the companies with recommendations or content. Instead, auditors or other users may be required to obtain the information from company websites, articles, communications with representatives of the company, or other nonstandard sources. The efforts of the users may further be unable to scale with the number of companies, which prevents insights, recommendations, and/or other features related to the information to be used with the companies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 shows an example estimation of entity size in accordance with one or ore embodiments;

FIG. 3 illustrates flowchart of estimating an entity size in accordance with one or more embodiments;

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. MODEL-DRIVEN ESTIMATION OF AN ENTITY SIZE

4. EXAMPLE EMBODIMENT

5. ESTIMATING AN ENTITY SIZE

6. COMPUTER NETWORKS AND CLOUD NETWORKS

7. MISCELLANEOUS; EXTENSIONS

8. HARDWARE OVERVIEW

### 1. General Overview

Techniques for estimating entity size are disclosed. Examples described herein, which should not be construed to limit the scope of any of the claims, refer to entities such as a company or a non-profit organization. The techniques include collecting features comprising a set of attributes of a company, wherein the set of attributes includes one or more of: an industry of the company, a number of data points associated with the company within the platform, characteristics of the company website, technologies used by the company, a number of subsidiaries, and a location of the company. The techniques also include applying a first machine learning model to the features to generate an estimate of a number of employees in the company. Input into the machine learning model includes, but is not limited to, a presence score corresponding a detected presence of a company in each of a set of forums. The techniques further include matching the first number of employees to a configuration parameter mapped to one or more users of a platform and updating, for the one or more users, a user interface of the platform to include output representing the first entity.

One or more embodiments described in this Specification and/or recited in the claims may not be included in this General Overview section.

### 2. Architectural Overview

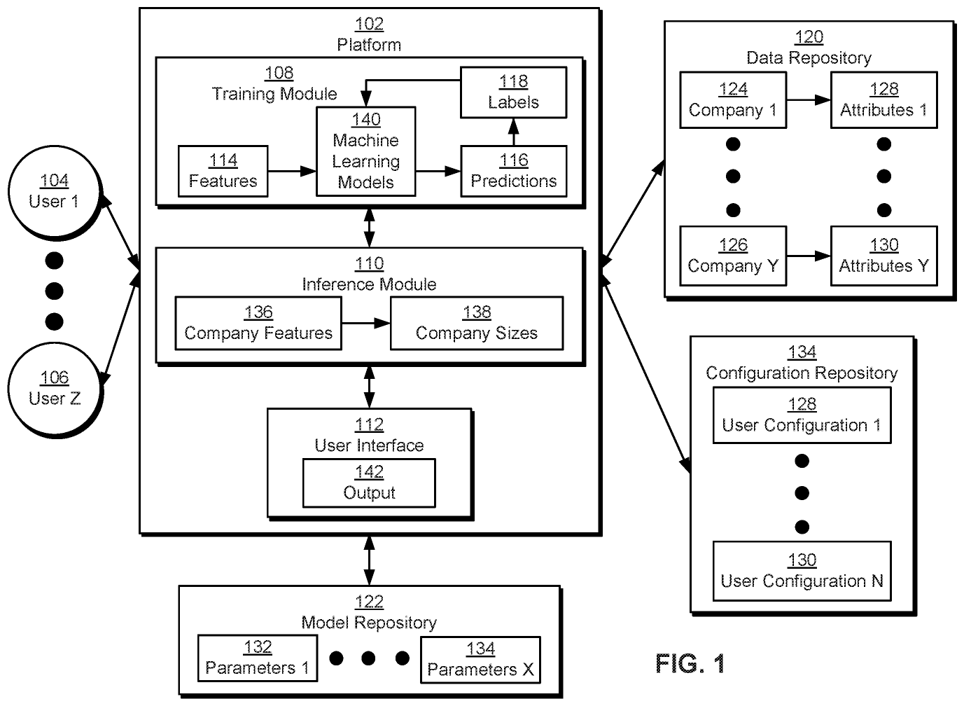

FIG. 1 illustrates a system in accordance with one or more embodiments. As illustrated in FIG. 1, the system includes a platform 102 that interacts with a set of users (e.g., user 1 104, user z 106) to perform tasks and/or provide functionality related to a set of companies (e.g., company 1 124, company y 126). For example, platform 102 includes a cloud-based or online system that allows the users to search, browse, and/or otherwise discover companies and/or attributes (e.g., attributes 1 128, attributes y 130) of the companies.

More specifically, platform 102 includes a user interface 112 that displays output 142 related to the companies and corresponding attributes. For example, user interface 112 includes a graphical user interface (GUI), web-based user interface, command line interface (CLI), voice user interface, and/or another type of user interface that allows the users to access the functionality of platform 102. Output 142 includes, but is not limited to, search results, recommendations, notifications, alerts, reports, tables, spreadsheets, visualizations, files, database records, and/or other representations of companies, attributes, and/or other data in a data repository 120. In turn, the users can use output 142 to conduct targeting, advertising, marketing, sales, outreach, job-hunting, collaboration, negotiation, and/or other activities with the companies and/or representatives of the companies.

In some embodiments, data repository 120 stores identifiers for the companies, as well as attributes that characterize and/or provide insight into the companies. For example, a given record in data repository 120 may include a company name and/or a unique identifier for a company, as well as attributes such as the company's industry, location, number of employees, revenue, organizational structure, description, leadership, technographics, news and announcements, initial public offerings (IPOs), funding rounds, acquisitions, product launches, and/or events.

In one or more embodiments, data repository 120 includes attributes for companies that are obtained from verified public sources and/or sourced by humans. For example, one or more components of platform 102 include functionality to extract data related to a company from government filings, new articles, press releases, social media, job listings, blog posts, data partners, human auditors, and/or other data sources. The data may be extracted using natural language processing techniques, machine learning techniques, and/or human annotation. The data may then be stored in fields for the corresponding attributes that are mapped to an identifier for the company in data repository 120.

In turn, one or more components of platform 102 generate, in user interface 112, output 142 that includes and/or is related to the companies and the corresponding attributes in data repository 120. For example, output 142 includes one or more lists of companies with records in data repository 120. A user may click on an entry in the list to navigate to a screen of user interface 112 that displays some or all attributes stored in the company's record in data repository 120.

Such output 142 may additionally be customized to individual users of platform 102. As mentioned above, the users may interact with user interface 112 to identify, browse, filter, and/or search for companies with certain attribute values or combinations of attribute values. Each user includes an optional user configuration (e.g., user configuration 1 128, user configuration n 130) that stores the user's preferences, settings, saved searches, and/or other explicit or implicit criteria related to the user's use of platform 102.

For example, a user configuration is created for a user and stored in a configuration repository 134 after an account for the user is created with platform 102 and/or the user specifies one or more preferences, settings, saved searches, and/or other criteria related to his/her use of platform 102. The criteria may be obtained from explicit feedback from the user, such as the user's selection or exclusion of specific modules, subscriptions, notifications, and/or other mechanisms for generating or modifying output 142 in user interface 112. The criteria may also, or instead, be generated based on implicit preferences of the user, such as patterns related to the user's browsing, searching, filtering, or other types of behavior or interactions with user interface 112.

In some embodiments, user configurations in configuration repository 134 include configuration parameters identifying companies that match the users' preferences or needs. For example, a user configuration includes a first configuration parameter specifying a range of 500-1000 employees in a company and/or a second configuration parameter specifying a range of $5-10 M for the revenue of a company over a period (e.g., a month, a quarter, a year, etc.). As a result, platform 102 and/or user interface 112 may generate output 142 containing companies with numbers of employees and/or revenues that fall within the specified ranges. Output 142 may additionally exclude companies with numbers of employees and/or revenues that do not fall within the specified ranges, thereby customizing user interface 112 to the criteria in the user configuration.

### 3. Model-Driven Estimation of an Entity Size

Those skilled in the art will appreciate that data repository 120 may lack some or all attributes for many companies because such attributes are not publicly available or easily verified. For example, data repository 120 may lack industries, headcounts, revenues, and/or other types of attributes for smaller and/or privately held companies because such information cannot be found in public content related to the companies and/or because these companies exist in much higher numbers than can be manually processed by human auditors for platform 102 in a reasonable amount of time.

In one or more embodiments, platform 102 includes functionality to estimate or predict certain attributes of companies, based on known and/or user-provided attributes of other companies. More specifically, platform 102 uses one or more machine learning models 140 to estimate attributes representing company sizes 138 for companies that lack values of the attributes in data repository 120.

First, a training module 108 in platform 102 trains and/or updates machine learning models 140 based on training data that includes features 114 and labels 118 for companies. Machine learning models 140 include, but are not limited to, regression models, decision trees, support vector machines, neural networks, deep learning models, factorization machines, ensemble models, clustering techniques, Bayesian networks, naïve Bayes classifiers, clustering techniques, and/or other types of models for performing statistical and/or mathematical inference.

Features 114 inputted into machine learning models 140 include attributes of the companies. For example, features 114 for a given company may include the company's industry, sub-industry, overview, description, keywords (e.g., extracted from the overview and/or a description of the company), location (e.g., country), technologies used (e.g., based on technographic data for the company), and/or exchange in which the company is listed. Features 114 may also, or instead, specify the presence or absence of a parent company for the company (e.g., when the company is a subsidiary of the parent company), the number of child (e.g., subsidiary) companies the company has, and/or the number of acquisitions the company has made. Features 114 may also, or instead, include measures of the company's level or types of activity within platform 102, such as the number of lists in platform 102 in which the company appears, the number of conferences in which the company participates, and/or the number of customer relationship management (CRM) tools and/or accounts to which the company is synchronized. Features 114 may also, or instead, include the number of users and/or devices with Internet Protocol (IP) addresses, email addresses, locations, and/or other attributes that can be used to associate the users and/or devices with the company.

Labels 118 include company sizes 138 for each company in the training dataset. For example, labels 118 for a company include one or more numeric values representing the company's number of employees and/or revenue.

In one or more embodiments, features 114 and labels 118 are obtained from records in data repository 120 and/or inferred or calculated based on fields in the records. For example, a given example in training data for machine learning models 140 includes features 114 that map to a company's attributes in data repository 120, which in turn have been obtained from public records and/or provided by human auditors. The same example also includes one or more labels 118 that are set to the company's number of employees and/or revenue, which are also obtained from public records (e.g., websites, publications, financial reports, etc.) and/or provided by human auditors. In another example, a classification model is used to infer the industry or sub-industry of a company based on other attributes of the company, and the inferred industry or sub-industry are added to features 114 for the company.

In some embodiments, various metrics representing the company's activity and/or information within any forum can by analyzed by the platform 102 to generate a presence score. A presence score represents an overall presence or visibility of the company in various forums as detected by platform 102. A company's presence in a forum corresponds to instances of the company being referenced within, participating in, influencing, or otherwise being associated with a forum. Forums, as referred to herein, includes any place, meeting, or medium that allows for communication. Examples of forums include recruiting websites, marketing platforms, comment boards, conferences, advertising materials, blogs, publications, news distributors, marketing/sales materials, advertising presence, presence within news forums, discussion boards, and investment panels. Such forums can be provided by platform 102, linked to platform 102, and/or external to platform 102.

In an embodiment, the presence score for a company is computed based on the presence of the company within a particular set of forums. The particular set of forums for evaluating a company's presence may be selected based on the presence of other companies with similar attributes (e.g., same industry) having a presence in the same particular set of forums. As an example, if established tech companies are determined to have significant presence in developer forums and tech forums, then a target company within the tech industry may be evaluated based on presence within developer forums and tech forums.

As an example, the presence score for a company may be computed based on a weighted average of respective presence scores computed for each of a set of forums being used to evaluate the company. As another example, the presence score for a company may be computed based on a combination of n best forum-specific presence scores. In both examples, each forum-specific score may be calculated based on the number of occurrences of the company's name or account in a corresponding forum, with a higher forum-specific score reflecting a greater number of occurrences of the company in the forum and a lower forum-specific score indicating a lower number of occurrences of the company in the forum.

To train machine learning models 140, training module 108 inputs features 114 into each machine learning model and obtains one or more predictions 116 as output from the machine learning model. Training module 108 then uses a training technique (e.g., stochastic gradient descent, least squares, maximum likelihood estimation, etc.) and/or one or more hyperparameters to update the parameters (e.g., parameters 1 132, parameters x 134) of the machine learning model so that predictions 116 better reflect the corresponding labels 118.

For example, training module 108 trains a first regression model to predict a label representing the number of employees in a company and/or a bucketized range of the number of employees in the company, based on features 114 that include the company's presence score, company's industry, sub-industry, overview, description, keywords, location, technologies used, exchange, status as a subsidiary of a parent company, number of subsidiaries, number of acquisitions, and/or other attributes. Training module 108 also, or instead, trains a second regression model to predict another label representing the revenue of the company and/or a bucketized range of revenues for the company, based on features 114 that include the company's industry, sub-industry, and/or number of employees (either predicted or known). During training of each regression model, training module 108 updates the coefficients (i.e., parameters) of the regression model so that the regression model is fitted to the corresponding values of features 114 and labels 118 in the training data. In turn, the trained regression model is able to generate predictions 116 that substantially match labels 118 based on the corresponding features 114.

After machine learning models 140 are trained and/or updated, training module 108 stores parameters of each machine learning model in a model repository 122. Training module 108 also, or instead, provides the latest parameters of a given machine learning model to an inference module 110 and/or other components of platform 102.

Inference module 110 applies machine learning models 140 to company features 136 for additional companies to generate predictions 116 or estimates of company sizes 138 for the companies. Continuing with the above example, inference module 110 obtains the latest version of each machine learning model from training module 108 and/or model repository 122. Inference module 110 also obtains and/or generates a first list of companies that lack known and/or verified numbers of employees in data repository 120. Inference module 110 applies the first machine learning model to company features 136 for each company in the first list to generate an estimate for the number of employees at the company. Inference module 110 also obtains and/or generates a second list of companies that lack known and/or verified revenues in data repository 120. Inference module 110 then applies the second machine learning model to additional company features 136 that include the industry and known or estimated number of employees for each company in the second list to generate an estimate of the company's revenue. Finally, inference module 110 stores the estimated numbers of employees and/or revenues as representations of company sizes 138 for the corresponding companies in data repository 120 and/or another data store.

In turn, user interface 112 generates output 142 based on company sizes 138 estimated by inference module 110. For example, user interface 112 matches a company's known or predicted number of employees, revenue, and/or other attributes to criteria in user configurations for a subset of users in platform 102. The criteria may include ranges of values for the attributes (e.g., 500-1000 employees in a company, a revenue of $10-25 M, etc.), which are obtained from the users' explicit or implicit preferences, settings, and/or saved searches. User interface 112 then generates one or more notifications, alerts, recommendations, search results, and/or other output 142 that includes or identifies the company to the subset of users. Output 142 includes basic information related to the company (e.g., company name, location, industry, etc.) and/or a link to a screen in user interface 112 that displays additional attributes and/or insights related to the company (e.g., number of employees, revenue, subsidiary companies, parent companies, acquisitions, technographics, funding status, keywords, website, social media accounts, etc.). Thus, output 142 allows the users to conduct further research and/or develop plans for conducting sales, marketing, advertising, job-seeking, collaboration, negotiation, purchasing, and/or other types of activity or communication with the company within and/or outside platform 102.

By estimating a company's number of employees and/or revenue based on other attributes of the company, platform 102 improves the availability and/or granularity of data for the company. The data is additionally matched to explicit or implicit preferences of users of platform 102 and outputted in user interface 112 to the users. As a result, the users are able to interact with user interface 112 and/or platform 102 with greater efficiency and/or effectiveness, which improves the functionality and/or value of platform 102 to the users. The increased efficiency and/or relevance of user interface 112 and output 142 to the users' preferences also reduces subsequent processing, network, and/or storage overhead associated with inefficient querying or use of platform 102 by the users (e.g., in manually identifying companies that meet the users' needs or preferences). The increased relevance of output 142 to the users further reduces resource consumption associated with conducting digital communication between the users and companies that are inaccurately identified as matching the users' needs or preferences. Consequently, the system of FIG. 1 may improve the use of technologies, computer systems, and user interfaces for providing data, insights, and/or features related to companies and/or fostering or enabling digital or online communication or interaction with the companies.

In one or more embodiments, platform 102 may include more or fewer components than the components illustrated in FIG. 1. For example, training module 108, inference module 110, and user interface 112 may include, execute with, or exclude one another. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 4, titled “Computer Networks and Cloud Networks.”

In one or more embodiments, a data repository (e.g., data repository 120, model repository 122, configuration repository 134) is any type of storage unit and/or device (e.g., a file system, database, collection of tables, or any other storage mechanism) for storing data. The data repository may be implemented or may execute on the same computing system as training module 108, inference module 110, and user interface 112 or on a computing system that is separate from training module 108, inference module 110, and user interface 112. The data repository may be communicatively coupled to training module 108, inference module 110, and user interface 112 via a direct connection or via a network. Further, the data repository may include multiple different storage units and/or devices. The multiple different storage units and/or devices may or may not be of the same type or located at the same physical site.

In one or more embodiments, platform 102 refers to hardware and/or software configured to perform operations described herein for estimating attributes of companies and customizing user interface 112 and/or output 142 to users based on the estimated attributes. Examples of such operations are described below.

In an embodiment, platform 102 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, user interface 108 refers to hardware and/or software configured to facilitate communications between a user and platform 102. User interface 108 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of user interface 108 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, user interface 108 is specified in one or more other languages, such as Java, C, or C++.

### 4. Example Embodiment

A detailed example is described below for purposes of clarity. Components and/or operations described below should be understood as one specific example, which may not be applicable to certain embodiments. Accordingly, components and/or operations described below should not be construed as limiting the scope of any of the claims.

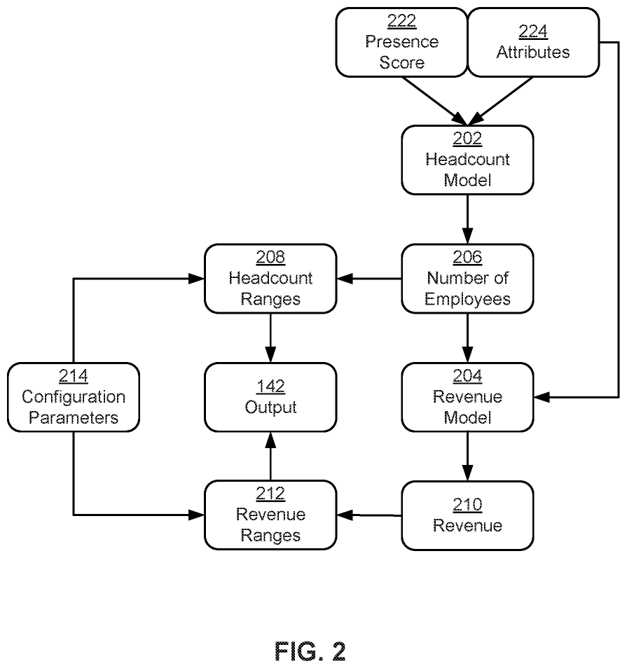

FIG. 2 shows an example estimation of entity size in accordance with one or ore embodiments. Such estimation may be performed by one or more components of platform 102 of FIG. 1, including (but not limited to) training module 108, inference module 110, and/or user interface 112.

First, features that include a presence score 222 and attributes 224 of an entity (e.g., a company, organization, or another grouping of people) are inputted into a headcount model 202. As described above, presence score 222 may be calculated based on the entity's detected presence in forums such as (but not limited to) recruiting websites, marketing platforms, comment boards, conferences, advertising materials, blogs, publications, news distributors, marketing/sales materials, advertising presence, presence within news forums, discussion boards, and investment panels.

For example, presence score 222 may include multiple sub-scores, with each sub-score representing the entity's presence or visibility in a corresponding forum. Each sub-score may be calculated as the number of occurrences of the entity within the corresponding forum (e.g., the number of job posts by the entity in a recruiting or employment website, the number of posts by the entity in a comment board or news forum, the number of articles mentioning the entity in one or more publications, the number of conferences in the entity's industry in which the entity appears, etc.). Presence score 222 may then be calculated as a weighted combination of the sub-scores for the entity. Within the weighted combination, each sub-score is multiplied or scaled by a weight that represents the relative importance of the corresponding forum to the entity's general or public presence. The value of the weight may be set based on human input (e.g., common or expert perceptions of the prominence or importance of the forum), by a supervised or unsupervised machine learning technique, and/or based on other criteria.

Attributes 224 include data related to a “profile” of the entity. For example, attributes 224 include embeddings, one-hot encodings, and/or other representations of the entity's industry, sub-industry, overview, description, keywords (e.g., extracted from the overview and/or description), location (e.g., country), technologies used (e.g., based on technographic data for the entity), and/or exchange in which the entity is listed. Attributes 224 may also, or instead, include Boolean and/or numeric values that specify the presence or absence of a parent company for the entity (e.g., when the entity is a subsidiary of the parent company), the number of child (e.g., subsidiary) companies the entity has, and/or the number of acquisitions the entity has made. Attributes 224 may also, or instead, include numeric values representing the entity's level or types of activity within platform 102, such as the number of lists in platform 102 in which the entity appears, the number of conferences in which the entity participates, and/or the number of customer relationship management (CRM) tools and/or accounts to which the entity is synchronized. These numeric values may be included in features inputted into headcount model 202 in lieu of or in addition to presence score 222. Attributes 224 may also, or instead, include numeric values representing the number of users and/or devices with Internet Protocol (IP) addresses, email addresses, locations, and/or other attributes that can be used to associate the users and/or devices with the entity.

Headcount model 202 includes a regression model and/or another type of machine learning model that predicts a number of employees 206 in the entity based on presence score 222, attributes 224, and/or other features for the entity. For example, headcount model 202 calculates number of employees 206 as a linear combination of the features and a set of coefficients (e.g., model parameters) that are specific to headcount model 202. In turn, number of employees 206 includes a numeric value that is greater than or equal to 0, which represents an estimate of the headcount of the entity by headcount model 202.

Next, number of employees 206 is inputted with some or all attributes 224 and/or other features for the entity into a revenue model 204, and revenue model 204 generates an estimate of revenue 210 for the entity. Like headcount model 202, revenue model 204 includes a regression model and/or another type of machine learning model. Features inputted into revenue model 204 include number of employees 206, which can be predicted by headcount model 202 and/or obtained from a verified source (e.g., the entity, a human auditor, a publication, a government filing, etc.). The features also, or instead, include the industry of the entity and/or other attributes 224. In turn, revenue model 204 calculates revenue 210 as a numeric value representing an estimate of the entity's income over a given period (e.g., a month, a quarter, a year, etc.). For example, revenue model 204 estimates revenue 210 as a linear combination of the features and a set of coefficients (e.g., model parameters) that are specific to revenue model 204.

Number of employees 206 and revenue 210 are matched to headcount ranges 208 and revenue ranges 212, respectively, in configuration parameters 214 for users of platform 102. For example, configuration parameters 214 obtained from a user configuration for a user include a headcount range specifying the minimum and maximum numbers of employees in entities in which the user is interested. Configuration parameters 214 in the same user configuration also, or instead, include a revenue range specifying the minimum and maximum revenue of entities in which the user is interested. As a result, the entity matches configuration parameters 214 when number of employees 206 falls within the headcount range and/or revenue 210 falls within the revenue range.

Such matching of number of employees 206 and revenue 210 to configuration parameters 214 may also be performed on a conjunctive or disjunctive basis. For example, configuration parameters 214 may include a saved search that specifies a headcount range of 50-100 employees and a revenue range of $1-2 M. As a result, the entity matches the saved search when number of employees 206 falls between 50 and 100 and revenue 210 falls between $1 M and $2 M. Alternatively, the saved search may specify that at least one of the headcount range or the revenue range be met. Thus, the entity matches the saved search when the entity has between 50 and 100 employees or between $1 M and $2 M in revenue.

Finally, output 142 is generated within user interface 112 of platform 102 based on matches of the entity's number of employees 206 to headcount ranges 208 in configuration parameters 214 and/or the entity's revenue 210 to revenue ranges 212 in configuration parameters 214. For example, user interface 112 outputs the name, number of employees 206, revenue 210, and/or other attributes of the entity to users with configuration parameters 214 that match number of employees 206, revenue 210, and/or other attributes 224 of the entity. In turn, the users can use the outputted information to develop strategies and/or priorities related to interacting with the entity or representatives of the entity in various contexts.

### 5. Estimating an Entity Size

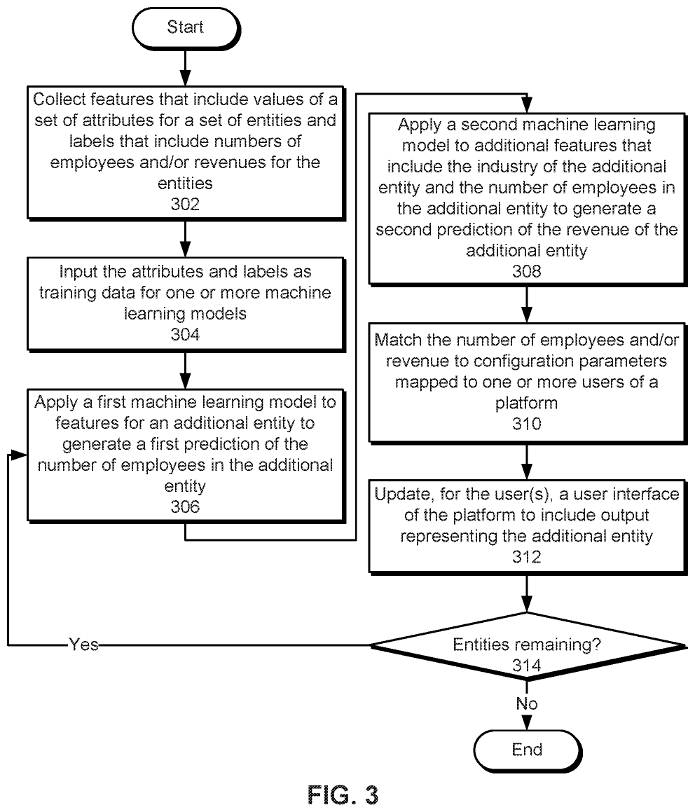

FIG. 3 illustrates a flowchart of estimating entity size in accordance with one or more embodiments. In one or more embodiments, one or more of the steps may be omitted, repeated, and/or performed in a different order. Accordingly, the specific arrangement of steps shown in FIG. 3 should not be construed as limiting the scope of the embodiments. The operations described below with reference to FIG. 3 describe estimating a size of an entity. Examples and embodiments described herein are applicable to any type of entity such as non-profit organizations, for-profit organizations, associations, memberships, or any other grouping of people with a particular purpose.

Initially, features that include a set of attributes of a set of entities and labels that include numbers of employees and/or revenues for the companies are collected (operation 302). For example, the features and/or labels include attributes that are obtained from websites, publications, financial reports, and/or other public records. The features and/or labels also, or instead, include attributes that are procured and/or verified by data partners and/or human auditors.

In some embodiments, the features include a presence score corresponding to a detected presence of an entity in each of a set of forums. The presence score is calculated by determining a set of sub-scores based on occurrences of the entity in the set of forums and combining the set of sub-scores with a set of weights into the presence score. The features also, or instead, include a set of keywords extracted from a website for the entity. The features also, or instead, include a set of technologies used by the entity, which may be obtained from public sources, data partners, and/or human auditors. The features also, or instead, include a status of an entity as a subsidiary of a parent entity and/or a number of child companies of the entity. The features also, or instead, include a location extracted from a public record related to the entity. The location includes, but is not limited to, a country of the entity and/or a stock exchange in which the entity is listed.

Next, the attributes and labels are inputted as training data for one or more machine learning models (operation 304). For example, a first machine learning model is trained to predict the number of employees in an entity, given the entity's industry, presence score, location, and/or other attributes. A second machine learning model is trained to predict an entity's revenue, given the entity's industry, number of employees, and/or other attributes.

After the machine learning models are trained, the machine learning models are used to infer and/or predict entity sizes for entities not in the training dataset. More specifically, the first machine learning model is applied to features for an additional entity to generate a prediction of the number of employees in the entity (operation 306). The second machine learning model is also, or instead, applied to additional features that include the industry of the additional entity and the number of employees in the additional entity to generate a second prediction of the revenue of the additional entity (operation 308). The predicted number of employees, revenue, and/or bucketized ranges of values associated with one or both predictions may then be stored in a database with an identifier for the additional entity.

The number of employees and/or revenue are matched to configuration parameters mapped to one or more users of a platform (operation 410). For example, the configuration parameters include a minimum and/or maximum number of employees, a minimum and/or maximum revenue, and/or other criteria associated with the users' preferences, settings, and/or saved searches related to entities with records in the platform. As a result, the additional entity may match a given user's configuration parameters when the additional entity's number of employees falls within the range represented by the minimum and maximum number of employees in the configuration parameters and/or the additional entity's revenue falls within the range represented by the minimum and maximum revenue in the configuration parameters.

A user interface of the platform is updated to include output representing the additional entity (operation 310). For example, the additional entity is outputted to the user(s) in a recommendation, search result, notification, alert, and/or other type of user-interface component provided by the platform.

Operations 306-312 may be repeated for remaining entities (operation 314) that lack known and/or user-verified numbers of employees and/or revenues. For example, operations 306-312 may be used to estimate entity sizes and/or generate user interface output related to the estimates for some or all entities and/or users in the platform.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread). A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

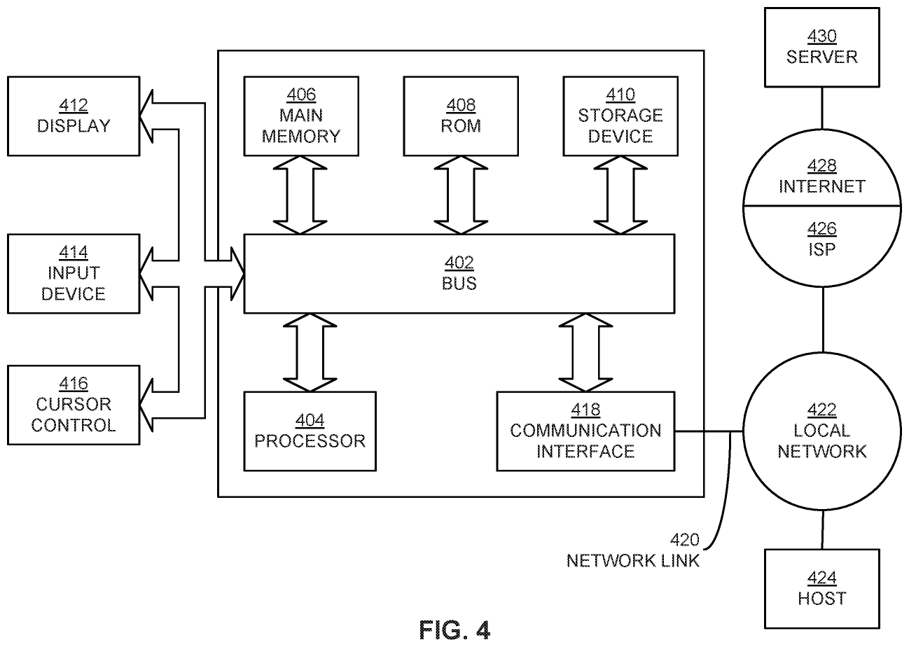

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, optical tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
collecting features comprising a set of attributes of a first entity, wherein the set of attributes comprises an industry of the first entity and a presence score corresponding to a detected presence of the entity in each of a set of forums;
applying a first machine learning model to the features to generate a first prediction of a first number of employees in the first entity;
matching the first number of employees to a configuration parameter mapped to one or more users of a platform; and
updating, for the one or more users, a user interface of the platform to include output representing the first entity.

2. The medium of claim 1, wherein the operations further comprise:
applying a second machine learning model to additional features comprising the industry and the first number of employees in the first entity to generate a second prediction of a revenue for the first entity.

3. The medium of claim 1, wherein the operations further comprise:
collecting, for a set of entities, values of the set of attributes and labels comprising numbers of employees in the set of entities; and
inputting the set of attributes and the labels as training data for the first machine learning model.

4. The medium of claim 3, wherein collecting the labels comprises:
obtaining a second number of employees in a second entity from a public record related to the second entity.

5. The medium of claim 4, wherein the public record comprises at least one of a website, a publication, and a financial report.

6. The medium of claim 1, wherein the configuration parameter comprises at least one of a preference, a saved search, and a setting.

7. The medium of claim 1, wherein collecting the features comprises:
determining a set of sub-scores of the presence score based on occurrences of the first entity in the set of forums; and
combining the set of sub-scores with a set of weights into the presence score.

8. The medium of claim 1, wherein collecting the features comprises:
extracting a set of keywords from a website for the first entity; and
including the set of keywords in the set of attributes.

9. The medium of claim 1, wherein collecting the features comprises:
identifying a set of technologies used by the first entity; and
including the set of technologies in the set of attributes.

10. The medium of claim 1, wherein collecting the features comprises:
determining a status of the first entity as a subsidiary of a first parent entity;
determining a number of child companies of the first entity; and
including the status and the number of child companies in the set of attributes.

11. The medium of claim 1, wherein collecting the features comprises:
extracting a location associated with the first entity from a public record; and
including the location in the set of attributes.

12. The medium of claim 11, wherein the location comprises at least one of a country of the first entity and a stock exchange in which the first entity is listed.

13. The medium of claim 1, wherein applying the first machine learning model to the features to generate the first prediction of the first number of employees in the first entity comprises:
combining the features with a set of coefficients in the first machine learning model to produce the first prediction.

14. A method, comprising:
collecting features comprising a set of attributes of a first entity, wherein the set of attributes comprises an industry of the first entity and a presence score corresponding to a detected presence of the entity in each of a set of forums;
applying a first machine learning model to the features to generate a first prediction of a first number of employees in the first entity;
matching the first number of employees to a configuration parameter mapped to one or more users of a platform; and
updating, for the one or more users, a user interface of the platform to include output representing the first entity.

15. The method of claim 14, further comprising:
applying a second machine learning model to additional features comprising the industry and the number of employees in the first entity to generate a second prediction of a revenue for the first entity.

16. The method of claim 14, further comprising:
collecting, for a set of entities, the set of attributes and labels comprising numbers of employees in the set of entities; and
inputting the set of attributes and the labels as training data for the first machine learning model.

17. The method of claim 14, wherein collecting the features comprises:
determining a set of sub-scores of the presence score based on occurrences of the first entity in the set of forums; and
combining the set of sub-scores with a set of weights into the presence score.

18. The method of claim 17, wherein the configuration parameter comprises a minimum number of employees and a maximum number of employees.

19. The method of claim 14, wherein the features further comprise at least one of a set of keywords for the first entity, a set of technologies used by the first entity, a status of the first entity as a subsidiary of a first parent entity, a number of child companies of the first entity, a number of acquisitions made by the first entity, a location of the first entity, and a stock exchange in which the first entity is listed.

20. An apparatus, comprising:
one or more processors; and
memory storing instructions that, when executed by the one or more processors, cause the apparatus to:
collect features comprising a set of attributes of a first entity, wherein the set of attributes comprises an industry of the first entity and a presence score corresponding to a detected presence of the entity in each of a set of forums;
apply a first machine learning model to the features to generate a first prediction of a first number of employees in the first entity;
match the first number of employees to a configuration parameter mapped to one or more users of a platform; and
update, for the one or more users, a user interface of the platform to include output representing the first entity.
